(19) United States
(12) Patent Application Publication
(10) Pub. No.: US 2006/0294288 A1
(43) Pub. Date: Dec. 28, 2006

(54) System and method for using protection keys to emulate a large region identifier space

(76) Inventors: Rohit Seth, Santa Clara, CA (US); Arun Sharma, Union City, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/166,455

(22) Filed: Jun. 24, 2005

(51) Int. Cl. G06F 12/00

(52) U.S. Cl. 711/6

(57) ABSTRACT

Host control logic for managing multiple guest virtual machines (VMs) may execute in a system having a processor with at least one region register (RR) and multiple protection key registers (PKRs). The system may also have storage responsive to the processor, with the host control logic stored at least partially in the storage. In one embodiment, the host control logic may reserve at least one of the PKRs, and may maintain virtual region registers (VRRs) to contain region identifier (RIDs) for the guest VMs. When switching context to a guest VM, the host control logic may update the reserved PKR with data to match an RID for the guest VM, and may update the RR with data to match a guest-region identifier (GRID) associated with the guest VM. The RID may also be stored in a key field of a TLB record. Other embodiments are described and claimed.

### FIELD OF THE INVENTION

The present disclosure relates generally to the field of data processing, and more particularly to methods and apparatuses for managing memory in a processing system.

### BACKGROUND

Multiple virtual machines (VMs) may run on a processing system with one or more processors. For instance, a processing system with one or more Intel® Itanium® 2 processors may support a host VM and two or more guest VMs. Alternatively, such a processing system may include a virtual machine monitor (VMM) and two or more guest VMs. For purposes of this disclosure, the terms “VMM” and “host VM” may be used interchangeably.

From a logical perspective, the VMM may run on top of the hardware platform, and the guest VMs may run on top of the VMM. Each guest VM may include an independent operating system (OS), and each OS may support multitasking. That is, each OS may support two or more live tasks or processes at once. Each process may have its own unique view of system memory.

One of the challenges of supporting multiple guest VMs is to provide effective and efficient memory management for each of the VMs.

### BRIEF DESCRIPTION OF THE DRAWINGS

The features and advantages of the present invention will become apparent from the appended claims and the following detailed description and drawings for one or more example embodiments, in which:

FIG. 1 is a block diagram depicting hardware and software in a suitable data processing environment to use protection keys to emulate a large region identifier space, in accordance with an example embodiment of the present invention;

FIG. 2 is a block diagram depicting at least some of the structures from FIG. 1, with example content to illustrate various operations to be performed in accordance with an example embodiment of the present invention; and

FIG. 3 provides a flowchart of a process for using protection keys to emulate a large region identifier space, in accordance with an example embodiment of the present invention.

### DETAILED DESCRIPTION

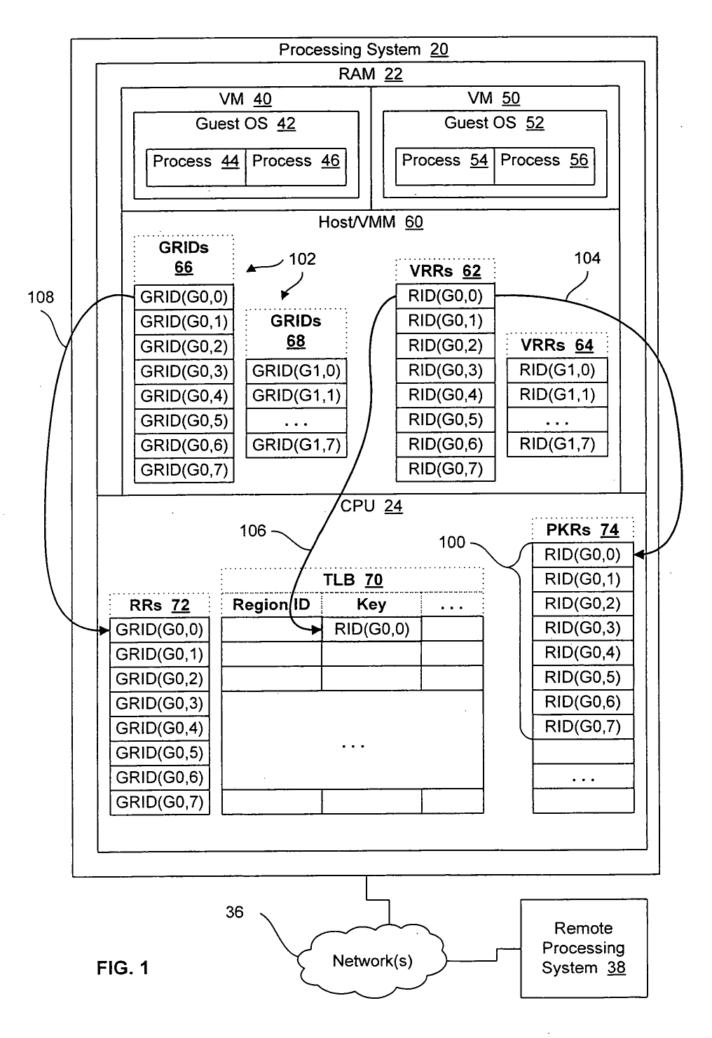

FIG. 1 is a block diagram depicting example hardware and software components in an example data processing environment to manage memory, in accordance with an example embodiment of the present invention. FIG. 1 and the following discussion are intended to provide a general description of a suitable environment in which certain aspects of the present invention may be implemented. As used herein, the terms “processing system” and “data processing system” are intended to broadly encompass a single machine, or a system of communicatively coupled machines or devices operating together. Exemplary processing systems include, without limitation, distributed computing systems, supercomputers, computing clusters, mainframe computers, mini-computers, client-server systems, personal computers, workstations, servers, portable computers, laptop computers, tablet processing systems, telephones, personal digital assistants (PDAs), handheld devices, mobile handsets, entertainment devices such as audio and/or video devices, and other devices for processing or transmitting information.

The data processing environment of FIG. 1 may include a processing system 20 that includes one or more processors or central processing units (CPUs) 24 communicatively coupled to various other components via one or more buses or other communication conduits or pathways. Processor 24 may be implemented as an integrated circuit (IC) with one or more processing cores. The components coupled to processor 24 may include one or more volatile or non-volatile data storage devices, such as random access memory (RAM) 22 and read-only memory (ROM). One or more buses may serve to couple RAM 22 and ROM with processor 24, possibly via one or more intermediate components, such as a hub, a memory controller, a bus bridge, etc. For purposes of this disclosure, the term “ROM” refers in general to non-volatile memory devices such as erasable programmable ROM (EPROM), electrically erasable programmable ROM (EEPROM), flash ROM, flash memory, non-volatile RAM (NV-RAM), etc.

Processor 24 may also be communicatively coupled to mass storage devices, such as one or more integrated drive electronics (IDE) drives, small computer systems interface (SCSI) drives, or other types of hard disk drives. Other types of mass storage devices and storage media that may be used by processing system 20 may include floppy-disks, optical storage, tapes, memory sticks, digital video disks, polymer storage, biological storage, etc.

Additional components may be communicatively coupled to processor 24 in processing system 20, including, for example one or more of each of the following: video, SCSI, network, universal serial bus (USB), and keyboard controllers; other types of device or input/output (I/O) controllers; network ports; other I/O ports; I/O devices; etc. Such components may be connected directly or indirectly to processor 24, for example via one or more buses and bus bridges. In some embodiments, one or more components of processing system 20 may be implemented as embedded devices, using components such as programmable or non-programmable logic devices or arrays, application-specific integrated circuits (ASICs), smart cards, etc.

Processing system 20 may be controlled, at least in part, by input from conventional input devices, such as a keyboard or keypad, a pointing device, etc., and/or by directives received from one or more remote data processing systems 38, interaction with a virtual reality environment, biometric feedback, or other input sources or signals. Processing system 20 may send output to components such as a display device, remote data processing system 38, etc. Communications with remote data processing system 38 may travel through any suitable communications medium. For example, processing systems 20 and 38 may be interconnected by way of one or more physical or logical networks 36, such as a local area network (LAN), a wide area network (WAN), an intranet, the Internet, a public switched telephone network (PSTN), a cellular telephone network, etc. Communications involving network 36 may utilize various wired and/or wireless short range or long range carriers and protocols, including radio frequency (RF), satellite, microwave, Institute of Electrical and Electronics Engineers (IEEE) 802.11, Bluetooth, optical, infrared, cable, laser, etc.

The invention may be described by reference to or in conjunction with associated data including instructions, functions, procedures, data structures, application programs, etc. which, when accessed by a machine, result in the machine performing tasks or defining abstract data types or low-level hardware contexts. Such data may be referred to in general as software, and it may be stored in volatile and/or non-volatile data storage.

For example, one or more storage devices accessible to or residing within processing system 20, such as ROM and/or a disk drive, may include some or all of a VMM 60 to be loaded into RAM 22, for example as part of a boot process when processing system 20 is powered up. VMM 60 may create one or more virtual machines (VMs) 40, 50, and VMM 60 may interact with VMs 40 and 50 in such a manner as to provide each VM with the illusion that the VM is operating in an independent processing system from any other VM. For instance, VMM 60 may provide each VM with its own distinct memory space, and VMM 60 may load a distinct OS into each VM. VMs 40 and 50 may be referred to as guest VMs 40 and 50, and the OSs operating in guest VMs 40 and 50 may be referred to as guest OSs 42 and 52, respectively.

Furthermore, each guest OS may support multitasking. Accordingly, at any one time, guest OS 42 may maintain multiple live processes 44, 46, and guest OS 52 may maintain multiple live processes 54, 56.

As illustrated in FIG. 1, from a conceptual perspective, VMM 60 executes or operates substantially at an intermediate level, between guest VMs 42 and 52 which operate at a higher or more abstract level, and the hardware of processing system 20 which operates at a lower, more physical level.

CPU 24 may include various structures to assist with memory management, such as a translation lookaside buffer (TLB) 70, a set of region registers (RRs) 72, and a set of protection key registers (PKRs) 74. Additional details regarding constructs such as TLB 70, RRs 72, and PKRs 74 may be obtained from the Intel® Itanium® Architecture Software Developer's Manual; Volume 2: System Architecture, Revision 2.1, October 2002 (hereinafter “the Itanium® System Architecture Manual”), which may currently be downloaded from the Internet at www.intel.com/design/itanium/documentation.htm.

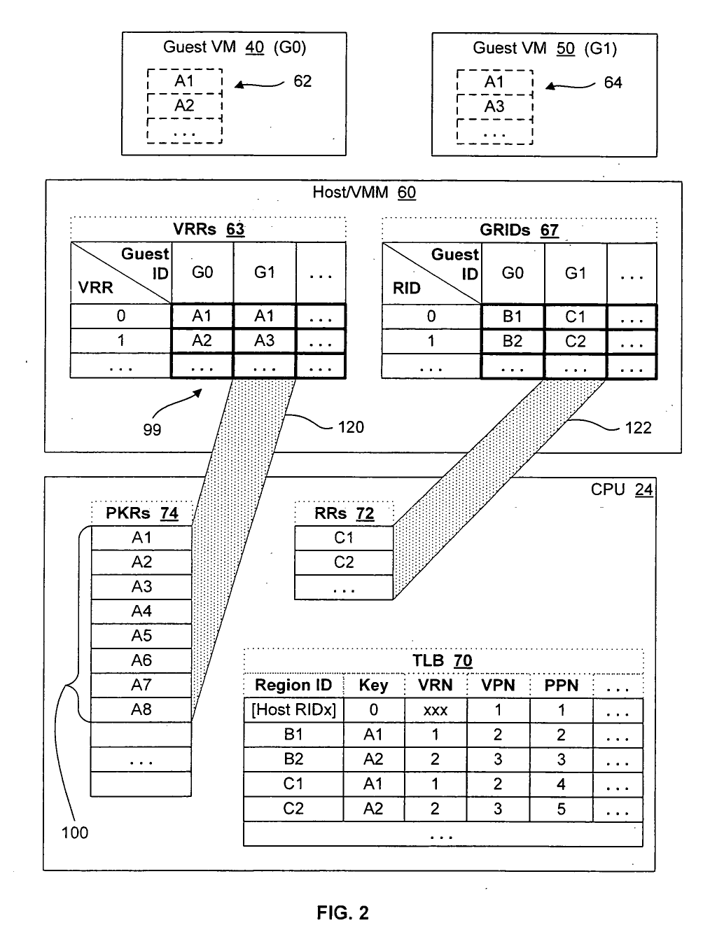

For instance, as illustrated in FIG. 4-2 of the Itanium® System Architecture Manual, the TLB includes translation entries to associate virtual page numbers (VPNs) with respective physical page numbers (PPNs). In particular, each translation entry includes multiple fields, such as a VPN field and a PPN field. Additional fields in a translation entry may include a region identifier (RID) field and a key field.

The manufacturer or distributor of a processor may publish certain architectural specifications for use by developers interested in working with that processor. Those specifications may include details regarding the basic architecture of the processor. For instance, those specifications may indicate how many RRs and PKRs the developers should expect to find in the processor. For example, page 2:49 of the Itanium® System Architecture Manual states that “[p]rocessor models have at least 16 protection key registers.” Structures that are described in such a manner may be referred to as architectural features. However, a processor may also include features that the architectural specifications do not describe, or do not specify as necessarily present. Such features may be referred to as non-architectural features.

In the example embodiment, processor 24 includes at least eight RRs 72 and at least twenty-four PKRs 74. That is, in addition to the sixteen architectural PKRs, processor 24 includes eight non-architectural PKRs. In alternative embodiments, other numbers of RRs and PKRs may be provided. Preferably, however, the actual number of available PKRs will exceed the number of architectural PKRs by at least a certain number, such as eight for example.

In a conventional system running a single OS without a VMM, the OS may use multiple RIDs for each live process. For instance, for a typical workload, an OS with 100 live processes may use five different RIDs for each of those processes, as well as three constant RIDs. Such a system may thus use 503 RIDs for one example workload. More or fewer RIDs may be used in different circumstances.

In the example embodiment, processing system 20 may include many different guest OSs, possibly including different types of OSs, and/or different instances of the same OS. In the example embodiment, guest VM 40 and guest OS 42 may be referred to in general as “Guest 0” (or “G0). Similarly, VM 50 and OS 52 may be referred to as “Guest 1” (or “G1”).

Furthermore, some or all of the guest OSs in a processing system may each use hundreds of RIDs, for example. VMM 60 may create and maintain multiple sets of virtual region registers (VRRs) 62, 64, with each set serving to emulate the physical RRs that each guest OS expects its platform to include. Accordingly, in FIG. 1, the values “RID(G0,0)”-“RID(G0,7)” in VRRs 62 represent example RID values that Guest 0 thought it was storing in region registers (i.e., example RID values that Guest 0 stored using commands or instructions designed for storing data in RRs). Similarly, the values “RID(G1,0)”-“RID(G1,7)” in VRRs 64 represent example RID values that Guest 1 requested to be stored in region registers.

In particular, in one embodiment, each guest OS may support multiple “live” processes (i.e., processes that might possibly be executed if swapped in, but not necessarily executing), but may only allow a smaller number of those processes (e.g., one process) to be “active” (i.e., executing) at any one time. Each guest OS may also create and maintain RIDs for each live process. An architectural specification for a platform may indicate that the platform supports or provides eight RRs, for example. Accordingly, the guest OS may load up to eight RIDs for the active process into eight VRRs. The operations performed by the guest OS may actually be operations designed to load RIDs into RRs, but in response to those operations, VMM 60 may actually load the specified RIDs into VRRs.

FIG. 2 is a block diagram depicting at least some of the structures from FIG. 1, with example content to illustrate various operations to be performed in accordance with an example embodiment of the present invention. For example, VRR set 62 is depicted in dashed lines within guest VM 40, to illustrated that guest VRRs 62 emulate physical RRs dedicated to guest VM 40. Likewise, VRR set 64 is depicted in dashed lines within guest VM 50, to illustrate that guest VRRs 64 emulate physical RRs dedicated to guest VM 50.

In addition, VRR sets 62 and 64 may be referred to collectively as VRRs 63. In FIG. 2, VRRs 63 are depicted as a table within VMM 60, with a collection of entries 99 arranged with a column for each guest OS, and a row for each RR or VRR. As illustrated, the content of the column in VRRs 63 (A1, A2, etc.) matches the respective content of the respective VRR sets 62 and 64 within guest VMs 40 and 50.

In addition, referring again to FIG. 1, VMM 60 may use data items known as guest-region identifiers (GRIDs) 66, 68, which should not be confused with RIDs. RIDs are region identifiers (IDs) that are used by a guest OS to reference or address particular memory spaces. By contrast, as described in greater detail below, GRIDs are identifiers that are assigned and/or used by a VMM to distinguish between region identifiers used by different guest OSs. Thus, while multiple guest OSs can use duplicate RIDs, in the example embodiment, all GRIDs are unique. Since GRIDs are assigned and/or used by the VMM, GRIDs may also be referred to as host-reserved region IDs (HRRIDs).

In particular, VMM 60 may create a predetermined number of GRIDs (e.g., eight) for each guest OS without using any duplicate GRIDs. In FIG. 1, the values “GRID(G0,0)”-“GRID(G0,7)” in GRID set 66 represent the GRIDs assigned by VMM 60 to the corresponding RIDs of Guest 0. Similarly, the values “GRID(G1,0)”-“GRID(G1,7)” in GRID set 68 represent the GRIDs assigned by VMM 60 to the corresponding RIDs of Guest 1. Referring again to FIG. 2, GRID sets 66 and 68 are depicted collectively as a table of GRIDs 67, with a column for each guest, and a row for each active RID. The GRID values illustrate that no duplicate GRID value are used in the example embodiment.

In one embodiment, VMM 60 may create an appropriate data construct (e.g., GRID table 67) and assign the GRID values in the process of initializing the environment and creating VMs 40 and 50. As described in greater detail below, VMM 60 may use those unique GRIDs to provide for differentiation between the RIDs of the active process of each Guest OS.

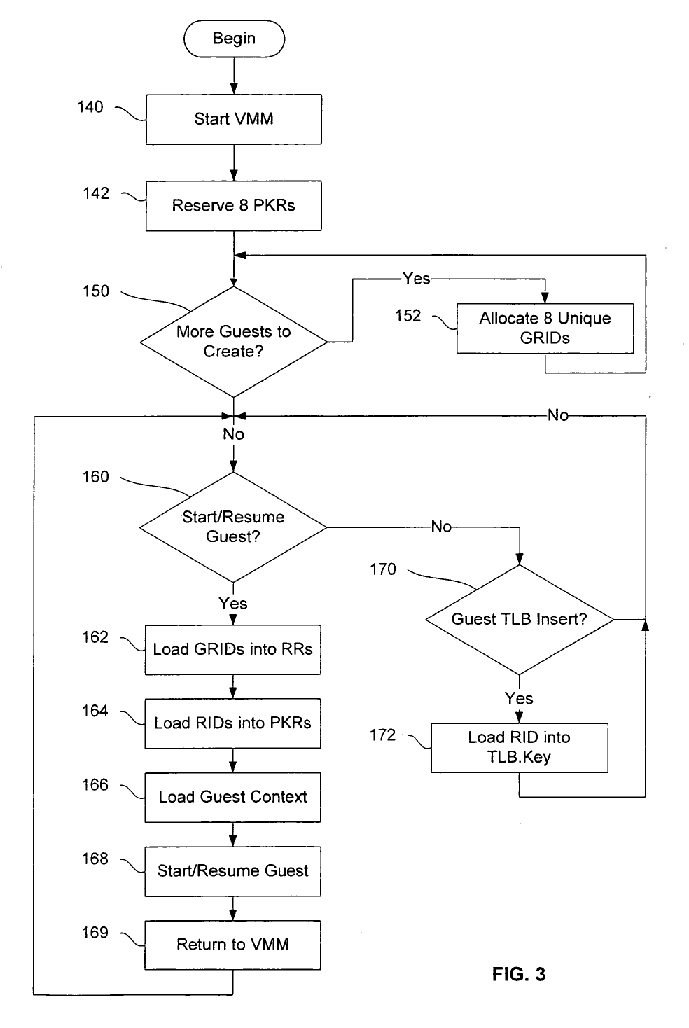

FIG. 3 provides a flowchart of a process for using protection keys to emulate a large region identifier space, in accordance with an example embodiment of the present invention. The process may begin with processing system 20 being powered on or reset, or in response to user input or initialization parameters requesting the launch of VMM 60, for instance. As indicated at block 140, processing system 20 may then begin to load, initialize, and start VMM 60. At block 142 VMM 60 may reserve a predetermined number of PKRs. In the example embodiment, for instance, VMM 60 may reserve eight PKRs. In FIG. 1, curly bracket 100 demarcates a set of reserved PKRs. Preferably, VMM 60 will leave at least as many PKRs unreserved as the architectural specification indicates should be available in the platform.

As depicted at block 150, VMM 60 may then begin creating guest VMs, for instance in accordance with predetermined configuration parameters. For each guest VM or guest OS, VMM 60 may allocate a predetermined number of GRIDs, as indicated at block 152, preferably keeping all GRIDs unique. In FIG. 1, arrows 102 represent the operation of allocating or reserving GRID sets 66 and 68 for Guest 0 and Guest 1, respectively. After allocating the GRIDs for each guest VM or OS, VMM 60 may determine whether control should be transferred to one of the guests, as indicated at block 160. In response to determining that control should be passed to a guest, VMM 60 may load all of the GRIDs for that guest OS into RRs72, as indicated at block 162. For instance, with regard to FIG. 1, arrow 108 represents the operation of loading GRID set 66 into RRs 72 in preparation for launching Guest 0.

In addition, if the guest OS to be started or resumed already has associated RIDs, VMM 60 may load all of the RIDs for that guest OS from the VRRs into the reserved PKRs, as indicated at block 164. In FIG. 1, arrow 104 represents the operation of copying RIDs from VRR set 62 into reserved PKRs 100, in preparation for starting or resuming Guest 0. As depicted at block 166 and 168, VMM 60 may then load any additional context needed by the guest OS, and may then transfer control to the guest OS.

As indicated at block 169, control may then eventually return to VMM 60, and the process may return to block 160, with VMM 60 again determining whether a guest is to be started or resumed. For instance, referring again to FIG. 2, if VMM 60 determines that Guest 1 should be launched, VMM 60 may load reserved PKRs 100 with the RIDs for Guest 1 from VRR table 63, as indicated by dotted bar 120, and VMM 60 may load RRs 72 with the GRIDs for Guest 1 from GRID table 67, as indicated by dotted bar 122.

Referring again to block 160 of FIG. 3, if a guest is not to be loaded or launched, VMM 60 may determine whether a guest OS has caused or requested a TLB insert, as depicted at block 170. For instance, a TLB insert may be caused by a guest executing an instruction such as insert translation cache (ITC) or insert translation register (ITR). Privileged instructions such as these may trap to the VMM, and the VMM can figure out exactly what the guest was trying to insert.

If no guest has caused or requested a TLB insert, the process may return to block 160 with VMM 60 again determining whether to start or resume a guest OS. However, if a guest OS has caused or requested a TLB insert, VMM 60 may insert the corresponding RID into the key field of the TLB record to be inserted into the TLB. For instance, the corresponding RID may be the RID for the memory region containing the memory address that caused the TLB insert. In FIG. 1, arrow 106 depicts the operation of loading an appropriate RID for Guest 0 into the key field of a TLB record. Additional details regarding the key field in TLB records to be used according to one possible embodiment of the present invention may be obtained from the Itanium® System Architecture Manual.

The process may then return to block 160, and VMM 60 may continue to swap in guest VMs and update TLB entries as appropriate, as described above. As a result of these operations, processor 24 may prevent each guest VM from accessing the memory regions of the other guest VMs. For instance, when a guest OS attempts to use a virtual address to access data from memory, processing system 20 may first check TLB 70 for the corresponding physical address. If none of the entries in TLB 70 matches on the virtual page, RID, and also on the key field, then processing system 20 will not use any existing entry from TLB 70 to access physical memory, but will instead perform further processing to determine the corresponding physical page. For example, when a request from guest OS 52 hits TLB 70, processor 24 will not use a physical page number from TLB 70 unless that physical page number comes from a TLB entry with a key that matches one of the RID values that VMM 60 has loaded into reserved PKRs 100. Accordingly, in the example embodiment, VMM 60 prevents each VM from accessing the data belonging to any other VM, by using the unique GRIDs. Further, VMM 60 prevents each process from accessing the data belonging to any other process in the same VM, by using the protection keys.

Consequently, VMM 60 need not flush TLB 70 when swapping between guest OSs. Moreover, processing system 20 need not impose artificially low limits on the number of RIDs available for each guest OS. Consequently, processing system 20 does not cause increased wrapping over of RIDs and a concomitant increase in the frequency of TLB flushes. VMM 60 may also provide for balanced sharing of TLB resources among guests. For example, if the working sets of processes within each guest are similar, then hardware is more likely to preempt TLB entries belonging to the same guest, instead of different guests. This result is likely because the hardware may use a pair containing the RID and the virtual page number (VPN) as the unique key for TLB lookups.

In the example embodiment, VMM 60 creates or reserves eight GRIDs for each guest VM, but the Guest OS in each guest VM may use hundreds of RIDs for hundreds of processes. Thus, VMM 60 uses a small number of protection keys to emulate a large region identifier space. For instance, N protection keys may be used to emulate 2N, 10N, or more RIDs.

Additional embodiments may provide additional features for supporting guest OSs that use protection keys (PKs). Such embodiments may emulate a large number of virtual PKs or guest PKs, using a smaller number of host PKs. For instance, a VMM may create a small number of host PKs, and then may use each host PK for multiple guests or for multiple PKs from a single guest. For instance, N host PKs may be used to support 2N, 10N, or more virtual PKs.

The VMM may maintain data that indicates which virtual PKs (i.e., which PKs used by the guest OSs) are mapped to each host PK. The VMM may also determine whether a guest OS will use a virtual PK that shares a host PK with other virtual PKs. In one embodiment, the VMM makes this determination whenever swapping in a guest OS. In an alternative embodiment, the VMM makes this determination when inserting TLB entries. If the host PK is shared (i.e., mapped to more than one virtual PK), before the VMM reuses the host PK for the guest OS to be swapped in, the VMM may get rid of all stale TLB entries (i.e., all entries which include the shared host PK).

Alternatively or in addition, the VMM may get rid of all stale TLB entries for a shared host PK before the VMM reuses the host PK for a TLB insert for a process of a guest OS. A guest OS for a VM may grant different virtual PKs to different processes. For example, the guest OS may grant virtual PKs “VPK1” and “VPK2” to processes “P1” and “P2,” respectively. In addition, the VMM may map both VPK1 and VPK2 to the same host PK (e.g., HPK3). In one embodiment, the VMM prevents each process within the VM from accessing data belonging to any other process. For instance, when inserting a TLB entry on behalf of P1, the VMM may check its data structure to determine whether VPK1 maps to a host PK that also maps to a virtual PK for another process. In the given example, VPK1 maps to HPK3, which is also mapped to VPK2. In such a case, the VMM may purge all TLB entries that have the TLB.key equal to the host PK (e.g., HPK3), and may then load the PKR with that host PK (e.g., HPK3).

To get rid of stale TLB entries, the VMM may perform a lazy flush. In one embodiment, the VMM executes a memory request without loading any PKRs with the shared PK, which may force a key miss fault. Then, in response to the key miss fault, the VMM may execute a purge to remove the stale TLB entries. The VMM may then load the shared host PK into a PKR, and may then let the guest OS handle the TLB key miss fault. For instance, the VMM may load the PKR, but may not service the fault. Instead, the VMM may forward the fault to the guest OS. The purging could be deferred to the point in time when the guest OS fault handler actually does a TLB insert.

In light of the principles and example embodiments described and illustrated herein, it will be recognized that the illustrated embodiments can be modified in arrangement and detail without departing from such principles. For example, although one or more example embodiments have been described with regard to certain numbers of components or data structures, such as eight RRs, etc., the present invention is not limited to utilization in the example embodiments described herein. Those of ordinary skill in the art will recognize that embodiments of the present invention may be used to advantage in a wide variety of different systems with different architectures, and/or different numbers of components, such as fewer or greater PKRs, RRs, VRRs, GRIDs, etc.

In addition, although the foregoing discussion has focused on particular embodiments, other configurations are contemplated. In particular, even though expressions such as “in one embodiment,” “in another embodiment,” or the like may appear herein, these phrases are meant to generally reference embodiment possibilities, and are not intended to limit the invention to particular embodiment configurations. As used herein, these terms may reference the same or different embodiments that are combinable into other embodiments.

Similarly, although example processes have been described with regard to particular operations performed in a particular sequence, it will be apparent to those of ordinary skill in the art that numerous modifications to the processes could be applied to derive numerous alternative embodiments of the present invention. For example, alternative embodiments may include processes that use fewer than all of the disclosed operations, processes that use additional operations, processes that use the same operations in a different sequence, and processes in which the individual operations disclosed herein are combined, subdivided, or otherwise altered.

Alternative embodiments of the invention also include machine accessible media containing instructions for performing the operations of the invention. Such embodiments may also be referred to as program products. Such machine accessible media may include, without limitation, storage media such as floppy disks, hard disks, CD-ROMs, DVDs, ROM, and RAM; as well as communications media such antennas, wires, optical fibers, microwaves, radio waves, and other electromagnetic or optical carriers. Accordingly, instructions and other data may be delivered over transmission environments or networks in the form of packets, serial data, parallel data, propagated signals, etc., and may be used in a distributed environment and stored locally and/or remotely for access and use by one or more single or multi-processor machines.

It should also be understood that the hardware and software components depicted herein represent functional elements that are reasonably self-contained so that each can be designed, constructed, or updated substantially independently of the others. In alternative embodiments, many of the components may be implemented as hardware, software, or combinations of hardware and software for providing the functionality described and illustrated herein. The hardware, software, or combinations of hardware and software for performing the operations of the invention may also be referred to as logic or control logic.

In view of the wide variety of useful permutations that may be readily derived from the example embodiments described herein, this detailed description is intended to be illustrative only, and should not be taken as limiting the scope of the invention. What is claimed as the invention, therefore, are all implementations that come within the scope and spirit of the following claims and all equivalents to such implementations.

What is claimed is:

1. A system, comprising:
a processor;
at least one region register (RR) in the processor;
multiple protection key registers (PKRs) in the processor;
storage responsive to the processor; and
host control logic stored at least partially in the storage, the host control logic operable to manage multiple guest virtual machines (VMs) in the system, the host control logic to perform operations comprising:
reserving at least one of the PKRs;
maintaining virtual region registers (VRRs) to contain region identifier (RIDs) for the guest VMs; and
in association with switching context to a guest VM, performing operations comprising:
updating the reserved PKR with data to match the RID in one of the VRRs for the guest VM; and
updating the RR with data to match a guest-region identifier (GRID) associated with the guest VM.

2. A system according to claim 1, the host control logic to perform operations comprising:
associating at least one unique GRID with each guest VM; and
supporting N RIDs with no more than M GRIDs, wherein M is less than half of N.

3. A system according to claim 1, wherein the processor comprises a translation lookaside buffer (TLB), the host control logic to perform further operations comprising:
in conjunction with storing a TLB record associated with the guest VM in the TLB, populating a key field of the TLB record with data to match the RID in one of the VRRs for the guest VM.

4. A system according to claim 1, the host control logic to perform further operations comprising:
associating at least one unique GRID with each guest VM.

5. A system according to claim 1, the host control logic to perform further operations comprising:
reserving a predetermined number of unique GRIDs for each guest VM.

6. A system according to claim 1, the host control logic to provide a predetermined number of VRRs for each guest VM, the host control logic to perform operations comprising:
generating N unique GRIDs for each guest VM, wherein N substantially matches the predetermined number of VRRs provided for each guest VM.

7. A system according to claim 1, the host control logic to support a guest operating system for at least one of the guest VMs, the guest OS to support an active process, the host control logic to perform operations comprising:
associating a unique GRID with each RID used by the active process of the guest OS.

8. A method, comprising:
reserving at least one protection key register (PKR) in a processor for use by host control logic to manage multiple guest virtual machines (VMs);
maintaining virtual region registers (VRRs) to contain region identifier (RIDs) for the guest VMs;
associating at least one guest-region identifier (GRID) with at least one of the guest VMs; and
in association with switching context to the guest VM, performing operations comprising:
updating the reserved PKR with data to match the RID in one of the VRRs for the guest VM; and
updating a region register (RR) in the processor with data to match the GRID associated with the guest VM.

9. A method according to claim 8, further comprising:
associating at least one unique GRID with each guest VM; and
supporting N RIDs with no more than M GRIDs, wherein M is less than half of N.

10. A method according to claim 8, wherein the processor comprises a translation lookaside buffer (TLB), the method further comprising:
in conjunction with storing a TLB record associated with the guest VM in the TLB, populating a key field of the TLB record with data to match the RID in one of the VRRs for the guest VM.

11. A method according to claim 8, further operations comprising:
associating at least one unique GRID with each guest VM.

12. A method according to claim 8, further operations comprising:
reserving a predetermined number of unique GRIDs for each guest VM.

13. A method according to claim 8, further comprising:
providing a predetermined number of VRRs for each guest VM; and
generating N unique GRIDs for each guest VM, wherein N substantially matches the predetermined number of VRRs provided for each guest VM.

14. A method according to claim 8, further comprising:
supporting a guest operating system for at least one of the guest VMs; and
associating a unique GRID with each RID used by an active process of the guest OS.

15. A program product comprising a machine-accessible medium containing instructions which, when executed by a processor, result in performance of operations comprising:
reserving at least one protection key register (PKR) in the processor for use by host control logic to manage multiple guest virtual machines (VMs);
maintaining virtual region registers (VRRs) to contain region identifier (RIDs) for the guest VMs;
associating at least one guest-region identifier (GRID) with at least one of the guest VMs; and
in association with switching context to the guest VM, performing operations comprising:
updating the reserved PKR with data to match the RID in one of the VRRs for the guest VM; and
updating a region register (RR) in the processor with data to match the GRID associated with the guest VM.

16. A program product according to claim 15, wherein the instructions, when executed, result in performance of further operations comprising:
associating at least one unique GRID with each guest VM; and
supporting N RIDs with no more than M GRIDs, wherein M is less than half of N.

17. A program product according to claim 15, wherein the processor comprises a translation lookaside buffer (TLB), and wherein the instructions, when executed, result in performance of further operations comprising:
in conjunction with storing a TLB record associated with the guest VM in the TLB, populating a key field of the TLB record with data to match the RID in one of the VRRs for the guest VM.

18. A program product according to claim 15, wherein the instructions, when executed, result in performance of further operations comprising:
reserving a predetermined number of unique GRIDs for each guest VM.

19. A program product according to claim 15, wherein the instructions, when executed, result in performance of further operations comprising:
providing a predetermined number of VRRs for each guest VM; and
generating N unique GRIDs for each guest VM, wherein N substantially matches the predetermined number of VRRs provided for each guest VM.

20. A program product according to claim 15, wherein the instructions, when executed, result in performance of further operations comprising:
supporting a guest operating system for at least one of the guest VMs; and
associating a unique GRID with each RID used by an active process of the guest OS.
